(19) United States
(12) Patent Application Publication
(10) Pub. No.: US 2025/0317017 A1
(43) Pub. Date: Oct. 9, 2025

(54) SINGLE FASTENER SHAFTLESS ROTOR

(71) Applicant: Ford Global Technologies, LLC, Dearborn, MI (US)

(72) Inventor: Adam Bangerter, Dearborn, MI (US)

(21) Appl. No.: 18/628,477

(22) Filed: Apr. 5, 2024

(51) Int. Cl. H02K 1/30; H02K 7/08

(52) U.S. Cl. CPC H02K 1/30; H02K 7/083

(57) ABSTRACT

Systems are provided for a rotor assembly including a single fastener. In one example, a system may include a shaftless rotor core positioned between a first end cap and a second end cap, and a fastener extending through the first end cap, second end cap, and a cavity formed by the rotor core to affix the first end cap and second end cap to the rotor core without any other fasteners.

### FIELD

The present description relates generally to rotor assemblies, and more particularly to a single fastener shaftless rotor.

### BACKGROUND/SUMMARY

A vehicle, such as a hybrid vehicle or a fully electric vehicle (EV), may use a rotor assembly including a shaft to drive a vehicle in a direction. In previous rotor assemblies, the shaft may extend through a center of a rotor core comprising lamination stacks and be secured to the rotor core via a fastening system comprising components, such as locknuts and washers. A shoulder may be formed at a first end of the shaft, and the lamination stacks may be held together between the shoulder at the first end of the shaft and fastening components coupled to a second end of the shaft. In this way, the shaft extends axially through the lamination stacks of the rotor core to align the lamination stacks and hold the components of the rotor together.

However, the inventors herein have recognized potential issues with such traditional rotor assemblies. For example, the shaft extending through the rotor core adds significant weight to the rotor assembly, and even more weight may be added to the rotor assembly due to corresponding fastening components and the shoulder of the shaft adapted to hold the rotor assembly together. Such weight may decrease an operational efficiency of a vehicle and place increased strain on the rotor assembly. Particularly with the spinning of the rotor core and shaft, the weight from the shaft and the shoulder running through the rotor core may lead to degradation of the rotor assembly components. Moreover, traditional fastening systems, such as a locknut and washer system, result in rotor assemblies that are relatively complex and time-consuming to manufacture. Further, rotor assemblies are often made of steel, which leads to high resource demand.

Previous attempts at solving some of the issues described above with a shaftless rotor assembly may include several fasteners which hold end caps to a rotor core. Having several fasteners may increase complexity of manufacturing due to complicated geometry of the end caps. Consequently, resource demand may be high for manufacturing such assemblies. Additionally, not having fasteners extending through lamination layers of the rotor allows the lamination layers to remain unmodified compared to conventional lamination layers used in rotor assemblies with a shaft therethrough.

In one example, the issues described above may be addressed by a rotor assembly, comprising: a first end cap; a second end cap; a rotor core positioned between the first end cap and the second end cap; a fastener extending axially through a center of the first end cap, through a cavity of the rotor core, and through a center of the second end cap, the fastener affixing the first end cap and second end cap to the rotor core without any other fasteners.

As one example, the first end cap and the second end cap may be adapted to align lamination stacks of the rotor core, such that alignment is achieved without a shaft. Further, the fastener may apply axial force to components of the rotor assembly for rotational coupling thereof. In this way, the rotor shaft is eliminated from a rotor core of the rotor assembly, allowing for a hollow rotor cavity, thus reducing the weight compared to a rotor including a rotor shaft. Additionally, a single fastener fastening system may reduce complexity compared to designs with several fasteners and allow for use of conventional lamination layers. Moreover, the rotor assembly disclosed herein may allow for hybridization of materials to reduce a demanded quantity of steel. For example, the end caps may be aluminum rather than steel, thus the weight and resource demand may be further reduced. Further still, in some examples, an inner diameter of the lamination layers may be increased in the rotor core disclosed herein, thus further reducing weight and resource demand.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example vehicle powertrain that may comprise a rotor assembly according to the present disclosure.

FIG. 2 shows a schematic diagram of an example of a vehicle comprising the rotor assembly according to the present disclosure.

FIG. 3 shows a cross-sectional view of an example rotor assembly according to the prior art.

FIG. 4 shows a cross-sectional view of an example rotor assembly according to the present disclosure.

FIG. 5 shows a cross-sectional view of another example rotor assembly according to the present disclosure.

### DETAILED DESCRIPTION

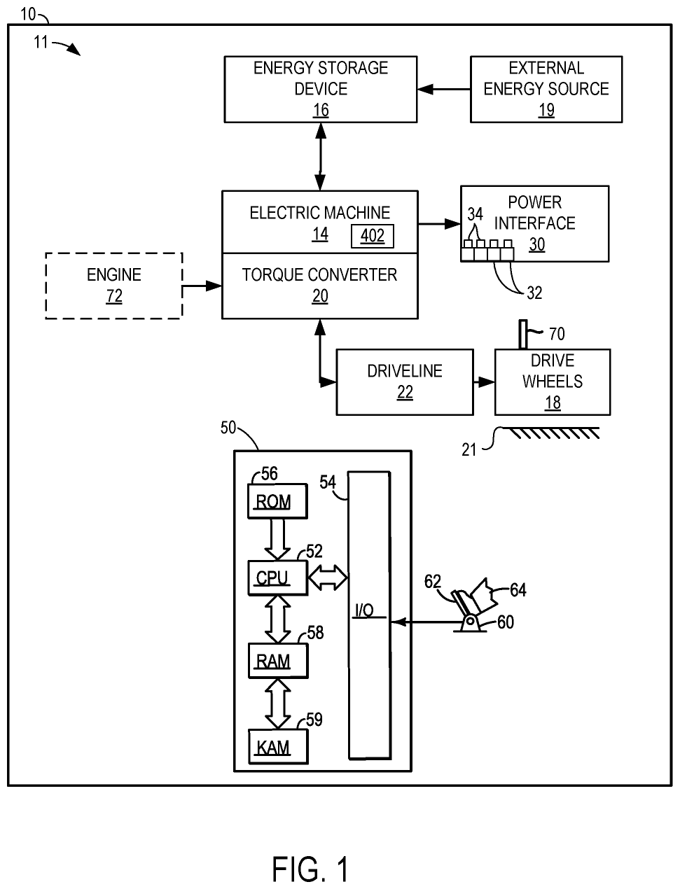

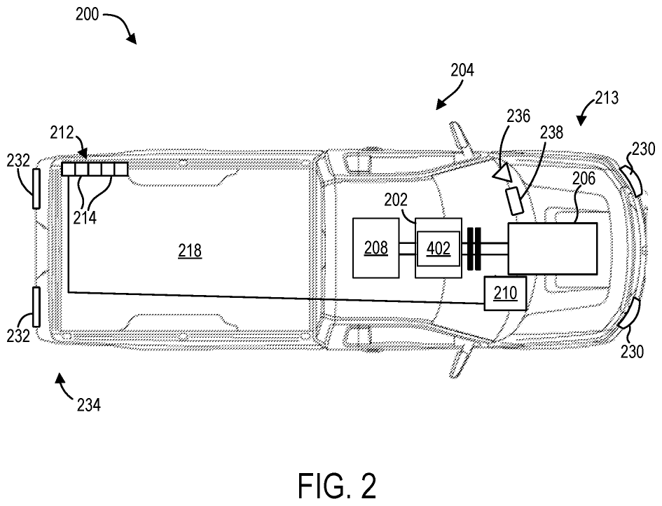

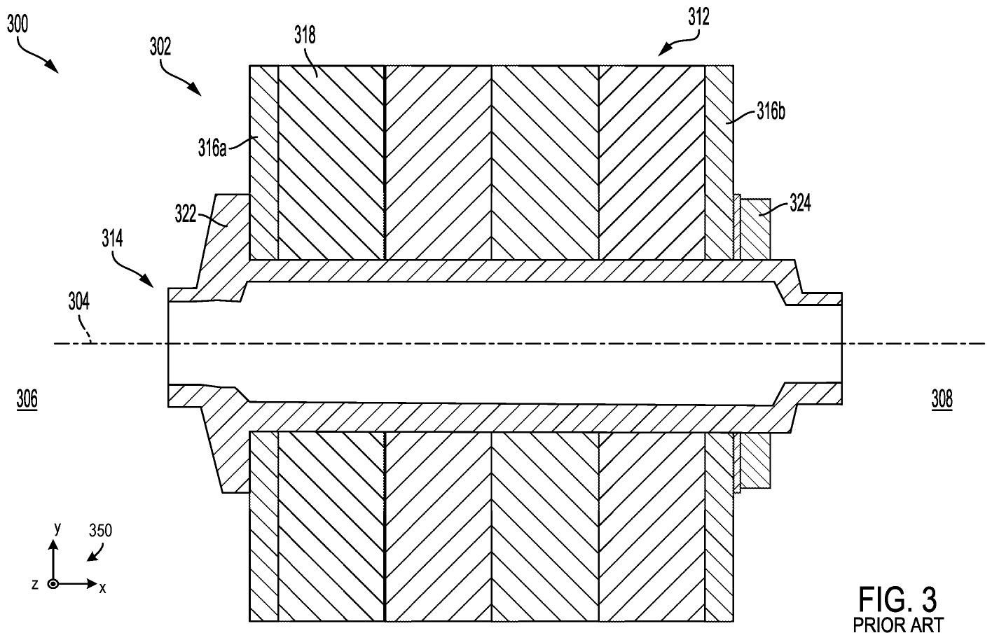

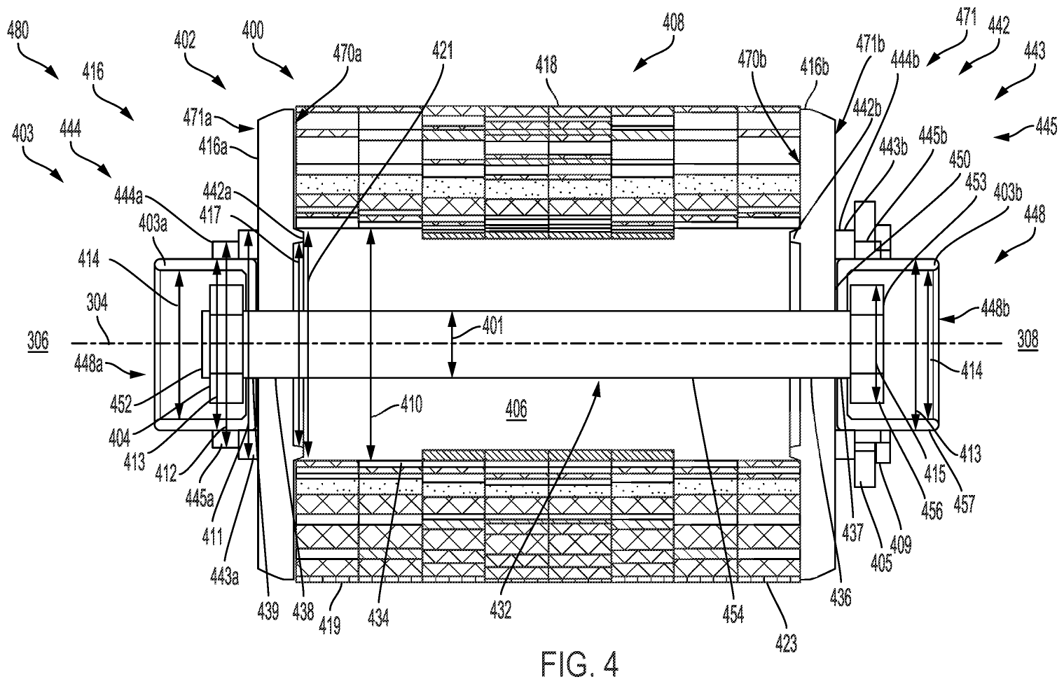

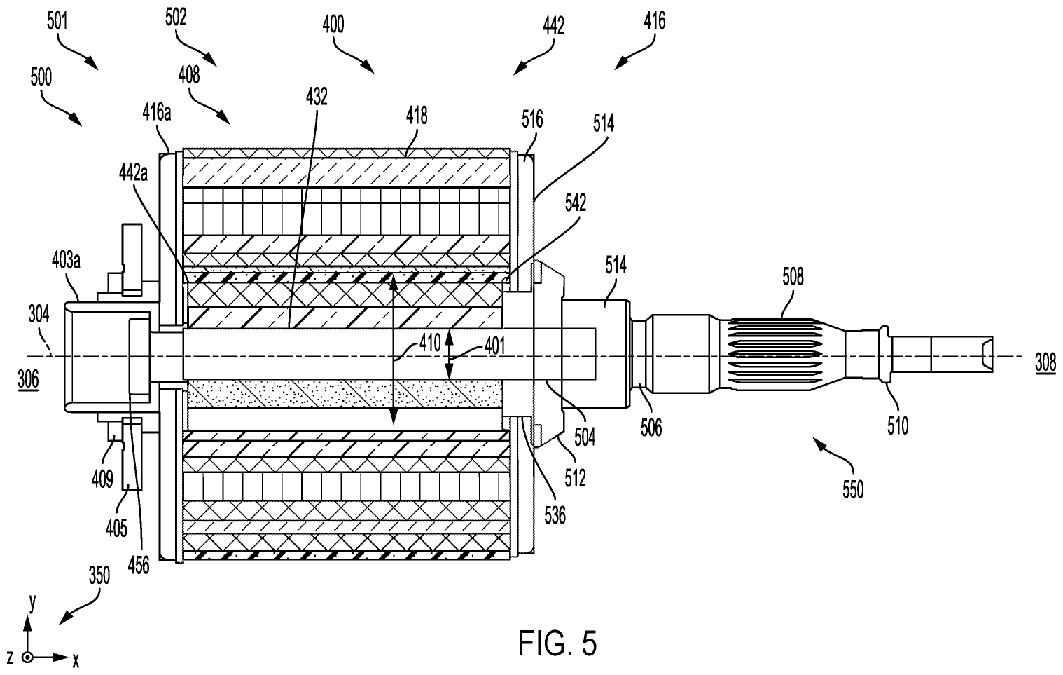

The following description relates to a rotor assembly, including a single fastener and a shaftless rotor. The shaftless rotor may not include a rotor shaft extending therethrough. Upon fastening the shaftless rotor with the single fastener, the rotor assembly may be formed. In one or more examples, the rotor assembly of the present disclosure may be incorporated into a vehicle, such as the vehicle shown at FIG. 2. For example, the rotor assembly may be incorporated into an electric machine of the vehicle, where the electric machine is part of the vehicle powertrain. There are various possible vehicle powertrain configurations into which the rotor assembly of the present disclosure may be incorporated, such as those shown at FIG. 1. Whereas rotor assemblies according to the prior art comprise a shaft extending therethrough and in face sharing contact with lamination stacks as shown at the FIG. 3 prior art example, the rotor assembly according to the present disclosure does not have a shaft in face sharing contact with lamination stacks. Rather, the rotor assembly according to the present disclosure may comprise a hollow rotor core that extends between two end caps and a single fastener (e.g., a bolt) that extends through the hollow core without being in face sharing contact with lamination stacks that define the hollow rotor core, where the two end caps may be drivingly coupled to an output via one or more cups and/or a drive end coupling rather than a shaft, as shown at FIGS. 4 and 5. As may further be seen at FIGS. 4 and 5, the single fastener may extend through the end caps and the hollow rotor core in a direction parallel to a rotational axis of the rotor assembly. In this way, the rotor assembly according to the present disclosure achieves the technical advantage of reduced weight compared to traditional rotor assemblies. Further, due to simplicity of the single fastener fastening system, manufacturing complexity may be reduced. Further still, material hybridization and increased lamination layer inner diameters may reduce weight and resource demand.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced. FIGS. 1-3 show schematics of example configurations with relative positioning of the various components. FIGS. 4 and 5 are shown approximately to scale, although other relative dimensions may be used. As used herein, the term “approximately” is construed to mean plus or minus five percent of the range unless otherwise specified.

Turning now to FIG. 1, an example of a vehicle 10 with a propulsion system 11 (e.g., electric propulsion system) is shown. Propulsion system 11 includes an electric machine 14 (e.g., energy conversion device). The electric machine 14 may be incorporated into an axle of the vehicle 10 and may comprise a rotor assembly 402 according to the present disclosure. The electric machine 14 is controlled via controller 50. In some examples, the vehicle propulsion system 11 may further include an engine 72, where the engine 72 may be an internal combustion engine.

The electric machine 14 is further shown coupled to an energy storage device 16, which may include a battery, a capacitor, inductor, or other electric energy storage device. The electric machine 14 can be operated to convert mechanical energy received from the vehicle driveline into an energy form suitable for storage by the energy storage device (e.g., provide a generator operation). The electric machine 14 can also be operated to supply an output (power, work, torque, speed, etc.,) to drive wheels 18 (e.g., provide a motor operation). It should be appreciated that the electric machine 14 may, in some embodiments, function only as a motor, only as a generator, or both a motor and generator, among various other components used for providing the appropriate conversion of energy between the energy storage device and the vehicle drive wheels. For instance, the electric machine 14 may include a motor, a generator, integrated starter generator, starter alternator, among others and combinations thereof. The electric machine 14 may also include or be coupled to an inverter. The inverter may be configured to condition electrical energy in and out of the energy storage device (e.g., high voltage battery). However, in other examples, the vehicle may not include an inverter.

The energy storage device 16 may be selectively coupled to an external energy source 19. For example, the energy storage device 16 device may be periodically coupled to a charging station (e.g., commercial or residential charging station), portable energy storage device, etc., to allow the energy storage device 16 to be recharged.

The electric machine 14 is coupled to a torque converter 20. The torque converter 20 is a fluid coupling designed to transfer rotational input from the electric machine 14 to a driveline 22. The driveline 22 includes a transmission with gearing and other suitable mechanical components (e.g., a gearbox, axles, transfer cases, etc.) designed to transfer rotational motion to the drive wheels 18. The drive wheels 18 may be supported by and drive vehicle 10 across a surface 21. The torque converter 20 and the electric machine 14 are depicted as an interconnected unit. However, in other examples, the torque converter 20 and the electric machine 14 may include discrete enclosures.

The electric machine 14 may include one or more clutches designed to selectively rotationally couple the machine's rotor to torque converter 20. For instance, the clutch or clutches may each include plates, splines, and/or other suitable mechanical components allowing the machine to be rotationally connected as well as disconnected from the engine or the torque converter.

The depicted connections between electric machine 14, driveline 22, and drive wheel 18 indicate transmission of mechanical energy from one component to another, whereas the connections between the electric machine 14 and the energy storage device 16 may indicate transmission of a variety of energy forms such as electrical, mechanical, etc. For example, torque may be transmitted from the electric machine 14 to drive the vehicle drive wheels 18 via the driveline 22. As described above, the electric machine 14 may be configured to operate in a generator mode and/or a motor mode. In a generator mode, propulsion system 11 receives some or all of the output from electric machine 14, which reduces the amount of drive output delivered to the drive wheel 18, or the amount of wheel caliper torque to the drive wheel 18. Such operation may be employed, for example, to achieve energy efficiency gains through energy recovery, increased engine efficiency (if included), etc. Further, the output received by the electric machine 14 may be used to charge an energy storage device 16. In motor mode, the electric machine 14 may supply mechanical output to the driveline 22, for example by using electrical energy stored in an electric battery. Additionally, an engine may supply rotational output to the driveline 22, in some instances.

The electric machine 14 may also be used to deliver electrical energy to external, auxiliary devices during power take-off. The electric machine 14 may run during power take-off but the drive wheels 18 are not in motion, allowing power output from the electric machine 14 to be directed at least partially towards operating the auxiliary devices. The vehicle 10 may include a power interface 30 arranged along an electrical circuit of the vehicle 10. The power interface may have a plurality of power outlets 32, each outlet electrically coupled to the electric machine, and plugging the auxiliary devices into the plurality of outlets allows power to be supplied to the auxiliary devices. Each of the power outlets 32 are coupled to or have a circuit breaker 34 integrated therein. The arrow extending between the electric machine 14 and the power interface 30 indicates the transfer of electrical energy therebetween. Further details of the power interface are described below, with reference to FIG. 2.

FIG. 1 also shows a controller 50 in the vehicle 10. The controller 50 receives signals from the various sensors of FIG. 1 and employs the various actuators of FIG. 1 to adjust vehicle operation based on the received signals and instructions stored in non-transitory memory of the controller 50. The electric machine, shown in FIG. 2 as a motor generator, may also be controlled by the controller 50. Specifically, controller 50 is shown in FIG. 1 as a conventional microcomputer including: microprocessor unit 52, input/output ports 54, read-only memory 56, random access memory 58, keep alive memory 59, and a conventional data bus. Controller 50 is configured to receive various signals from sensors coupled to the propulsion system 11 and send command signals to actuators in components in the vehicle, such as the electric machine 14. Additionally, the controller 50 is also configured to receive pedal position (PP) from a pedal position sensor 60 coupled to a pedal 62 actuated by a user 64. Therefore, in one example, the controller 50 may receive a pedal position signal and adjust actuators in the electric machine 14 based the pedal position signal to vary the rotational output of the electric machine 14. The sensors communicating with the controller 50 may include an electric machine sensor (e.g., resolver or Hall effect sensor for sensing a rotor position of the electric machine), and wheel speed sensor 70, accelerometer, etc. Additionally, the controller 50 may communicate electronically with one or more mobile applications. For example, a mobile application may enable the user to select stored auxiliary devices to be charged during a planned trip and based upon an electrical load profile stored in memory for the stored auxiliary devices, the mobile application may determine an amount of energy that will be spent during a planned trip. In one example, the controller 50 may include computer readable instructions, that when executed cause the controller 50 to measure an electrical load of one or more auxiliary devices plugged into the power interface and transmit a measurement of the electrical load to the mobile application. In another example, the controller 50 may include instructions that when executed cause the controller 50 to communicate one or more vehicle operating conditions to the mobile application and adjust one or more vehicle operating conditions in response to a command from the mobile application. An example of a mobile application is described in more detail with reference to FIG. 2.

In examples where the vehicle 10 comprises engine 72, engine 72 may have an output coupled to the torque converter 20 and may be incorporated into the axle of the vehicle. The engine 72 may be controlled via controller 50. Both the engine 72 and electric machine 14 may act as movers to drive the vehicle 10. For example, the vehicle 10 may be a hybrid vehicle. In examples including engine 72, rotational energy in the form of torque from the engine 72 or other rotational and mechanical energy from components may be converted into electrical energy by the electric machine 14. The output of the electric machine 14 to the torque converter 20 may act as input for the transfer and transformation of torque into electrical energy during hybrid operations.

Turning now to FIG. 2, a schematic diagram 200 of an example vehicle 204 is shown. As described above, the electric machine 14 of FIG. 1 may be an electric motor incorporated into an axle in some examples. In one or more examples, the electric motor 202 shown in FIG. 2 may be the same or similar to the electric machine 14 shown in FIG. 1. Similar to the vehicle powertrain shown at FIG. 1, the vehicle 204 shown in FIG. 2 comprises the rotor assembly 402 according to the present disclosure incorporated therein. That is, the rotor assembly 402 is shown incorporated into the electric motor 202 of the vehicle 204 at FIG. 2. Additionally, the vehicle 204 shown in FIG. 2 may be the same or similar to the vehicle 10 shown in FIG. 1. As shown in FIG. 2, the electric motor 202 may couple to an electric energy storage device 206 and a transmission 208 in a front end 213 of the vehicle 204. The transmission 208 may incorporate a torque converter, in one or more examples, such as the torque converter 20 shown in FIG. 1.

The vehicle 204 may also have a power interface 212 which may be disposed in a vehicle bed 218, as shown in FIG. 2. However, in other examples, the power interface 212 may be positioned in some other, accessible region of the vehicle 204. The power interface 212 has a plurality of power outlets 214 configured to receive electrical plugs of electrical devices, in one or more examples.

A powertrain control module (PCM) 210 may be included, for example, in the controller 50 of FIG. 1. The PCM 210 receives information from sensors arranged in a powertrain of the vehicle 204 and sends instructions to actuators of the powertrain. For example, the PCM 210 may receive a signal from a resolver of the electric motor 202 to infer a power output of the electric motor 202 and command adjustment of the output of the electric motor 202, e.g., field current, according to active motor operations and electrical loads. The PCM 210 may also control activation of vehicle accessories such as headlights 230, taillights 232, positioned at the front end 213 and a rear end 234 of the vehicle 204, respectively, a speaker or horn 236, and a cabin display panel 238. As such, illumination of the headlights 230 and taillights 232 may be enabled by the PCM 210 as well as emission of noises by the horn 236 and presentation of alerts and notifications at the cabin display panel 238.

The PCM 210 may also communicate with the power interface 212 and/or an auxiliary device through a communication link. The communication link may be a wireless communication network, such as a Bluetooth low energy (BLE) network, allowing the PCM 210 to monitor electrical and operating statuses of power interface 212 and any coupled the auxiliary devices.

Turning now to FIG. 3, a schematic 300 of a conventional rotor assembly 302 is shown according to the prior art that comprises a shaft 314 extending therethrough. As shown in the prior art example rotor assembly 302, the rotor assembly 302 may be centered on an axis 304, where the axis 304 is a central axis and longitudinal axis for the rotor assembly 302. The axis 304 may also be the axis of rotation for the rotor assembly 302. FIG. 3 shows reference axes 350, including an x-axis, a y-axis, and a z-axis, wherein the x-axis may be parallel to the axis 304. The rotor assembly 302 may have a first end positioned nearest to a first side 306 and a second end positioned nearest to a second side 308. The first side 306 and second side 308 may be opposite to one another along the x-axis.

The rotor assembly 302 may comprise a rotor core 312 that extends in an axial direction between a first end cap 316a and a second end cap 316b of the rotor assembly 302. As shown in FIG. 3, the first end cap 316a and the second end cap 316b are in the form of flat plates. In order to align the rotor assembly 302, a shaft 314 extends through the first end cap 316a, the center of the rotor core 312, and through the second end cap 316b. The shaft 314 further comprises a shoulder 322 at a first end of the shaft 314, where the shoulder 322 abuts an exterior surface of the first end cap 316a.

To hold the rotor assembly 302 together, the rotor assembly 302 further comprises a fastener 324 such as a lock nut at the second end of the shaft 314, that may be coupled to the shaft 314 and press against the second end cap 316b.

In this way, the shaft 314 running through the center of the first end cap 316a, the lamination stacks 318, and the second end cap 316b, with the shoulder 322 held against the first end cap 316a, in combination with the fastener 324 (e.g., a lock nut) tightened against the second end cap 316b, aligns and holds the example prior art rotor assembly 302 together.

As shown in FIG. 3, the fastener 324 is in surface sharing contact with and abuts the second end cap 316b, and the shoulder 322 is in surface sharing contact with and abuts the first end cap 316a. Additionally, the shaft 314 is in face sharing contact with the lamination stacks 318.

Turning now to FIG. 4, a cross section view 480 of a first example of rotor assembly 402 according to the present disclosure is shown, where the rotor assembly 402 includes a rotor 400 without a shaft, such as shaft 314 of FIG. 3, extending therethrough. Thus, the rotor 400 of the rotor assembly 402 may be referred to herein as a shaftless rotor. Further, the rotor assembly 402 may include a single fastener, such as a bolt, and no other fasteners. The fastener may extend through the rotor assembly 402, however, the fastener may not perform functions of a rotor shaft, including aligning lamination stacks and drivingly coupling the rotor assembly to exterior components, such as gears of a transmission (e.g., transmission 208 of FIG. 2). The rotor assembly configuration according to the preset disclosure with a fastener extending therethrough and end caps adapted to align the lamination stacks may reduce weight of the rotor assembly compared to a rotor with a shaft, such as the shaft 314 of FIG. 3, extending therethrough, and allow for hybridization of materials such that less expensive materials may be used in combination with steel to reduce resource demand, as is further described below. The reference axes 350 and the axis 304 are further shown in FIGS. 4 and 5 for comparison to the prior art example of FIG. 3.

The rotor assembly 402 may comprise a cavity 406 that is centered about the axis 304. Components of the rotor core 408, including one or more lamination stacks 418, radially surround and define the cavity 406 of the rotor assembly 402. Additionally, a length of the rotor assembly 402 may extend axially, parallel to the axis 304, between the first side 306 and second side 308. The axis 304 may be a central axis and longitudinal axis for the rotor assembly 402. The axis 304 may also be the axis of rotation for the rotor assembly 402.

The rotor core 408 may form a section of the rotor assembly 402 between end caps 416, including a first end cap 416a and a second end cap 416b. The first end cap 416a may be located at an axially opposite end of the rotor core 408 from the second end cap 416b. For example, the first end cap 416a may be located nearest to the first side 306, and the second end cap 416b may be located nearest to the second side 308. In this way, the cavity 406 may be enclosed by the end caps 416 and lamination stacks 418.

The rotor core 408 may comprise a plurality of lamination stacks 418. The lamination stacks 418 and the rotor core 408 may have electromagnetic properties, in one or more examples. For example, the lamination stacks 418 and rotor core 408 may incorporate windings, such that the lamination stacks 418 and rotor core 408 may form and act as an electromagnet when a current is applied. In some examples, the lamination stacks 418 may incorporate a plurality of permanent magnets, such that the lamination stacks 418 and rotor core 408 may act as part of an internal permanent magnet (IPM) electric machine. In other examples, the rotor core 408 may act as part of an induction electric machine, a reluctance electric machine, and the like.

In at least one example, the lamination stacks 418 may comprise steel, such as silicon steel or cold formed steel. Additionally, or alternatively, the lamination stacks 418 may be formed of a steel alloy, such as a nickel or cobalt alloy. In contrast with shaftless rotor assemblies wherein one or more fasteners directly physically connect with the lamination stacks, the fastener 432 does not physically contact the lamination stacks 418. For example, the lamination stacks 418 may not be in face sharing contact with the fastener 432. Thus, in some examples, the lamination stacks 418 may be sized and shaped as conventional lamination stacks (e.g., without modification for use in a rotor assembly according to the present disclosure). For example, the lamination stacks 418 may be substantially the same as the lamination stacks 318 shown in FIG. 3. Therefore, the complexity of the rotor assembly 402 may be reduced compared to other rotor assemblies, such as shaftless rotor assemblies. In other examples, the lamination stacks 418 may have an inner diameter 410 that is larger than an inner diameter of conventional lamination stacks such as the lamination stacks 318 in FIG. 3. In this way, an amount of materials used to form the lamination stacks 418 may be reduced, for example to a minimum amount demanded for electromagnetic function. Thus, resource demand and weight may be further reduced.

As further shown in the rotor assembly 402 at FIG. 4, the first end cap 416a and the second end cap 416b may be fastened to the rotor core 408 at axially opposite ends of the rotor core 408 via the fastener 432 such that the first end cap 416a is in face sharing contact with the rotor core 408 and the second end cap 416b is in face sharing contact with the rotor core 408. The fastener 432 may be the only fastener in the rotor assembly 402. Additionally, when fastened by the fastener 432, the end caps 416 and rotor core 408 may not move laterally relative to one another and the end caps 416 and rotor core 408 may be rotationally coupled via the fastener 432. There may not be any other fasteners holding the components of the shaftless rotor 400 (including the end caps 416 and the rotor core 408) together in the rotor assembly 402. Thus, the rotor assembly 402 may be a single fastener rotor assembly that includes a shaftless rotor fastened by a single fastener.

For example, the fastener 432 may be a bolt. The fastener 432 may comprise a body 454 and a head 456. The body 454 may include a threaded portion and a smooth portion (e.g., a shank). The threaded portion may be adjacent to a first end 452 of the body 454 near the first side 306, and ridges of the threaded portion (e.g., male threads) may protrude radially outwards from an outside surface of the body 454. The head 456 may be hexagonal in shape and physically coupled to or formed integrally with the body 454 near the second side 308. A retainer 404 may be hexagonal (e.g., approximately the same as or similar to the shape of the head 456) with a cylindrical hole axially aligned parallel to the axis 304. The cylindrical hole may have a diameter approximately the same as the body diameter 401 of the body 454. The retainer 404 may further have complimentary threads to the threaded portion of the body 454 on an inner surface of the retainer 404 (e.g., female threads lining the cylindrical hole). Thus, the threaded portion of the body 454 may be engagingly coupled to the retainer 404 via threading. In some examples, the retainer 404 may be removable from the fastener 432 such that the rotor assembly 402 may be disassembled and reassembled as desired. In other examples, the fastener 432 and the retainer 404 may be permanently coupled during assembly, such that the rotor assembly 402 may not be disassembled.

As shown in FIG. 4, the fastener 432 may be positioned axially along axis 304. The first end 452 of the fastener 432 may extend through the first end cap 416a and be partially outside of the cavity 406. A second end 453 (e.g., opposite of the first end 452) of the fastener 432 may extend through the second end cap 416b such that the head 456 may be positioned outside of the rotor core 408. A length of the fastener 432 spanning between the first end 452 and the second end 453 of the fastener 432 extends through a plurality of first holes 434 formed into the lamination stacks 418 that are axially aligned. The plurality of first holes 434 may form the cavity 406 and the fastener 432 may be positioned partially within the cavity 406 such that the fastener 432 is spaced away from walls of the lamination stacks 418 defining the plurality of first holes 434. The body diameter 401 of the body 454 may be less than the inner diameter 410 of the plurality of first holes 434, resulting in the cavity 406 being between the body 454 and inner facing walls of the lamination stacks 418 defining the plurality of first holes 434, in contrast with the prior art shown in FIG. 3 having the shaft 314 in face sharing contact with the lamination stacks 318. The second end 453 of the fastener 432 may extend through a second hole 436 formed through the second end cap 416b, and the first end 452 of the fastener 432 may extend through a third hole 438 formed into the first end cap 416a. Additionally, the first end 452 of the fastener 432 may extend through a fourth hole 439 formed into the first cup 403a, and the second end 453 of the fastener 432 may extend through a fifth hole 437 formed into the second cup 403b. In this way, the fastener 432 may extend axially through the cavity 406 of the rotor core 408, the end caps 416, and the cups 403 to pull the first end cap 416a and the second end cap 416b towards each other and hold the first end cap 416a, the lamination stacks 418, and the second end cap 416b of the rotor 400 together to form the rotor assembly 402.

In contrast with the shaft 314 of prior art rotor assembly 302 shown in FIG. 3 being in face sharing contact with the lamination stacks 318, the body 454 of the fastener 432 extending through the rotor assembly 402 may not contact the lamination stacks 418, in at least some examples. Thus, the fastener 432 may not align the lamination stacks 418 as the shaft 314 does in the rotor assembly 302 shown in FIG. 3. Alignment of the lamination stacks 418 to form the cavity 406 may be achieved by flanges 442 of the end caps 416, as is described further below.

The first end cap 416a may comprise a first flange 442a and second end cap 416b may comprise a second flange 442b. The first flange 442a and the second flange 442b may be chamfered and extend axially inward towards the rotor core 408. That is, the first flange 442a and the second flange 442b may extend axially towards each other. The first flange 442a and the second flange 442b may further be centered about the axis 304 of the rotor assembly 402. The first flange 442a and the second flange 442b may be cylindrical in shape. In this way, the first flange 442a and the second flange 442b may form ring shaped extensions at first interior facing side 470a and second interior facing side 470b of the first end cap 416a and the second end cap 416b, respectively. The flanges 442 may have an inner diameter 417 and an outer diameter 421, wherein the outer diameter 421 is approximately the same as the inner diameter 410 of the plurality of first holes 434 formed in the lamination layers of the lamination stacks 418.

Moreover, the first flange 442a and the second flange 442b may be in face sharing contact with the walls of the lamination stacks 418 that face inward towards the axis 304 and define the plurality of first holes 434. In at least one example, the first flange 442a and the second flange 442b may be in face sharing contact with a keyway cutout formed into such walls of the lamination stacks 418. Via face sharing contact of the first flange 442a and the second flange 442b with the inward facing walls of the lamination stacks 418, the first flange 442a and the second flange 442b may be adapted to align the lamination stacks 418 of the shaftless rotor 400.

In at least one example, the first flange 442a and the second flange 442b may be used to align the lamination stacks 418 by inserting the first flange 442a into a first end lamination stack 419 of the lamination stacks 418 and aligning the third hole 438 with the plurality of first holes 434 formed into the first end lamination stack 419. Similarly, the second flange 442b may be inserted into a second end lamination stack 423 of the lamination stacks 418 to align the second hole 436 with the plurality of first holes 434 formed into the second end lamination stack 423.

Thus, in contrast to the flat plate-shaped end caps in the prior art approaches (e.g., first end cap 316a and the second end cap 316b as shown in the prior art example at FIG. 3) the first end cap 416a and the second end cap 416b according to the present disclosure may instead comprise ring-shaped extensions in the form of the first flange 442a and the second flange 442b, respectively. Whereas prior art approaches (e.g., the prior art example at FIG. 3) utilize a shaft extending through the rotor assembly for alignment of lamination stacks, the rotor assembly 402 according to the present disclosure achieves alignment of lamination stacks with the flanges 442 rather than a shaft. The use of the flanges 442 to align the lamination stacks 418 may remove the demand for a shaft to be in face sharing contact with lamination stacks. Thus, because the body diameter 401 may be less than the inner diameter 410 such that the cavity 406 may remain hollow, weight and resource demand may be reduced.

In addition to the flanges 442, the end caps 416 may further define cylindrical openings 448 on outer facing surfaces 471 which may be adapted to receive cups 403. For example, the first end cap 416a may comprise a first cylindrical protrusion 444a on a first outer facing surface 471a defining a first cylindrical opening 448a adapted to receive the first cup 403a, and the second end cap 416b may comprise a second cylindrical protrusion 444b on a second outer facing surface 471b defining a second cylindrical opening 448b adapted to receive the second cup 403b. As described in the example disclosed herein, the cylindrical protrusions 444 are cylindrical in shape, however, protrusions from the end caps 416 may take other shapes in other examples without departing from the scope of this disclosure. Similarly, the cylindrical openings 448 may take other shapes than the example given herein, according to geometry of the cups 403 that the openings 448 may be adapted to receive.

The first cylindrical protrusion 444a may include a first cylindrical portion 443a with a first outer diameter 411 and a second cylindrical portion 445a with a second outer diameter 412. The first outer diameter 411 may be greater than the second outer diameter 412. Similarly, the second cylindrical protrusion 444b may include a third cylindrical portion 443b with the first outer diameter 411 and a fourth cylindrical portion 445b with the second outer diameter 412. The second cylindrical protrusion 444b may provide an interface for positioning a resolver rotor 405 and a resolver rotor retainer 409 thereon. For example, the resolver rotor 405 and the resolver rotor retainer 409 may circumferentially surround the fourth cylindrical portion 445b such that the resolver rotor 405 is fixed axially between the third cylindrical portion 443b and the resolver rotor retainer 409. Additionally or alternatively, the first cylindrical protrusion 444a may provide an interface for positioning a resolver rotor and resolver rotor retainer, such as the resolver rotor 405 and the resolver rotor retainer 409, thereon. The resolver rotor 405 may be rotationally coupled to a component, for example one of the end caps 416, of the rotor assembly 402. A resolver of which the resolver rotor 405 is a part of may be communicatively coupled to the controller such that signals may be transmitted therebetween. For example, the resolver, including the resolver rotor 405 and a resolver stator (not shown), may be used to measure an angle of rotation of the rotor assembly 402 about the axis 304.

The cylindrical protrusions 444 may also define cylindrical openings 448. For example, the first cylindrical protrusion 444a may have an inner cylindrical surface with inner diameter 413 defining the first cylindrical opening 448a of the first cylindrical protrusion 444a. Similarly, an inner surface of the hollow center of the second cylindrical protrusion 444b with inner diameter 413 may define the second cylindrical opening 448b. The cylindrical openings 448 may be adapted to receive the cups 403, as further described below.

The third cylindrical portion 443b and the fourth cylindrical portion 445b may, in some examples, have substantially the same shape as the first cylindrical portion 443a and the second cylindrical portion 445a, respectively, including substantially the same inner diameter 413. Thus, in some examples, the cylindrical protrusions 444 (e.g., the first cylindrical protrusion 444a and the second cylindrical protrusion 444b) may have substantially the same shape, having larger cylindrical portions 443 (e.g., first cylindrical portion 443a and third cylindrical portion 443b) closer to the lamination stacks 418 than smaller cylindrical portions 445 (e.g., second cylindrical portion 445a and fourth cylindrical portion 445b). In some examples, the first end cap 416a and the second end cap 416b may have substantially the same shape.

However, in other examples, one of the end caps 416 may be simplified. For example, because it may not be demanded that the first end cap 416a receive a resolver rotor and a resolver rotor retainer, such as resolver rotor 405 and resolver rotor retainer 409, the first cylindrical protrusion 444a may be simplified to have a single outer diameter (e.g., first outer diameter 411 or second outer diameter 412 rather than a combination thereof). In this way, complexity and resource demand may be reduced.

The first cup 403a and the second cup 403b may both be shaped with cylindrical walls and flat circular ends. For example, the second cup 403b may have a cylindrical wall with an inner diameter 414 and an outer diameter that is approximately the same as the inner diameter 413 of the inner surfaces of the cylindrical openings 448. The second cup 403b may further include a flat circular end 450 with the fifth hole 437 formed centrally therethrough. The cups 403 may be positioned outside of the rotor core 408 such that the end caps 416 are between the cups 403 and the lamination stacks 418. For example, the second cup 403b may be positioned in the second cylindrical opening 448b such that the flat circular end 450 may be in face sharing contact with the second outer facing surface 471b of the second end cap 416b and the cylindrical wall of the second cup 403b may be in face sharing contact with the inner surface of the second cylindrical opening 448b. Further, the cylindrical wall of the second cup 403b may extend axially beyond the second cylindrical protrusion 444b. The first cup 403a may be positioned in the first cylindrical opening 448a in a similar manner, with the first cup 403a in face sharing contact with the outer facing surface 471a of the first end cap 416a.

Additionally, the holes of the end caps 416 and cups 403 may be axially aligned with centerlines on the axis 304. For example, the fourth hole 439 and the third hole 438 may be aligned when the first cup 403a is placed in the first cylindrical opening 448a. Similarly, the fifth hole 437 and the second hole 436 may be aligned when the second cup 403b is placed in the second cylindrical opening 448b. Moreover, the body 454 may extend axially along the axis 304 through the second hole 436, the third hole 438, the fourth hole 439, and the fifth hole 437 such that the second hole 436, the third hole 438, the fourth hole 439, and the fifth hole 437 are aligned, thereby aligning the first end cap 416a, the second end cap 416b, the first cup 403a, and the second cup 403b.

As such, the centerlines of the plurality of first holes 434, the second hole 436, the third hole 438, the fourth hole 439, and the fifth hole 437 may extend along the axis 304. The surfaces of the second hole 436 and/or the third hole 438 may each have a threading complementary to threading of the fastener 432. In this way, portions of the fastener 432 may be threaded through the second hole 436 and/or the third hole 438. Additionally or alternatively, the fourth hole 439 and/or the fifth hole 437 may each have a threading complementary to the threading of the fastener 432 such that portions of the fastener 432 may be threaded through the fourth hole 439 and/or the fifth hole 437. However, in some examples, the surfaces of the second hole 436, the third hole 438, the fourth hole 439, and/or the fifth hole 437 may be smooth, and sized to fit the body 454 of the fastener 432 therethrough. The second hole 436, the third hole 438, the fourth hole 439, and the fifth hole 437 may be approximately the same size as each other. Further, the second hole 436, the third hole 438, the fourth hole 439, and the fifth hole 437 may have approximately the same diameter as the body diameter 401. In other examples, the second hole 436, the third hole 438, the fourth hole 439, and the fifth hole 437 may have larger diameters than the body diameter 401.

Additionally, the head 456 may be sized to be larger than the fifth hole 437 and smaller than the circular cross section of the cups 403. For example, a maximal diameter 415 of the head 456 may be larger than a diameter of the fifth hole 437 such that an inwards facing surface of the head 456 abuts the circular end 450 of the second cup 403b. Similarly, the retainer 404 may be sized to be larger than the fourth hole 439 such that an inwards facing surface of the retainer 404 abuts the first cup 403a.

Contrary to the example prior art rotor assembly 302 of FIG. 3 wherein the shoulder 322 abuts an outer surface of the first end cap 316a and the fastener 324 abuts an outer surface of the second end cap 316b to fasten the rotor assembly 302, the head 456 abuts the second cup 403b which abuts the second outer facing surface 471b, and the retainer 404 abuts the first cup 403a which abuts the first outer facing surface 471a to fasten the rotor assembly 402.

In this way, the fastener 432 may provide compression force axially, with respect to axis 304, to the first end cap 416a, first cup 403a, second end cap 416b, and second cup 403b. More specifically, the head 456 may apply a first axial force towards the rotor core 408, and the retainer 404 may apply a second axial force towards the rotor core 408, such that the first axial force and the second axial force are oriented opposite of one another. For example, the first axial force may be in a negative x-direction and the second axial force may be in the positive x-direction. The opposing axial forces may result in compression of the rotor assembly 402. The head 456 and the retainer 404 may further provide axial compression force when the retainer 404 is tightened (e.g., screwed onto the threaded portion of the body 454 using a torque wrench) to a desired torque (e.g., a snug torque) and/or a number of rotations. The axial compression of the first end cap 416a, the second end cap 416b, the first cup 403a, and the second cup 403b achieved by the fastener 432 may fasten the lamination stacks 418, and thereby prevent the lamination stacks 418 from moving or separating in axial directions with respect to the axis 304. Thus, the fastener 432 may prevent axial movement of components of the rotor assembly 402 relative to one another.

Additionally, the axial compressive force may maintain alignment of the lamination stacks such that radial movement with respect to the axis 304 is prevented. For example, as described above, the first end lamination stack 419 may be positioned according to the first flange 442a and the second end lamination stack 423 may be positioned according to the second flange 442b. The rest of the lamination stacks 418 may be positioned therebetween with the plurality of first holes 434 axially aligned, and the axial compression exerted by the fastener 432 and the retainer 404 may maintain the alignment of the lamination stacks 418, including the first end lamination stack 419 and the second end lamination stack 423. Therefore, axial and radial movement of the lamination stacks 418 may be prevented.

Thus, via the configuration shown in FIG. 4, the first end cap 416a, second end cap 416b, the first cup 403a, the second cup 403b, and lamination stacks 418 may be aligned, such that the axis 304 is concentric to the aforementioned components and the centerlines of the plurality of first holes 434, the second hole 436, the third hole 438, the fourth hole 439, and the fifth hole 437 may be axially aligned. The fastener 432 may further extend through each of the plurality of first holes 434, the second hole 436, the third hole 438, the fourth hole 439, and the fifth hole 437 for coupling of the rotor assembly 402. Specifically, the components of the shaftless rotor 400 (including the end caps 416, the lamination stacks 418, and the cups 403) may be rotationally coupled with the fastener 432 and the retainer 404 when the fastener 432 and the retainer 404 are positioned to form the rotor assembly 402 and tightened.

As described above, the cups 403 may provide interfaces for the fastener 432 and the retainer 404 to exert axial compressive forces towards each other. Additionally, the cups 403 may each be a journal of a journal bearing. For example, the cups 403 may each be circumferentially surrounded by a bearing (not shown), including a liner and a housing, for support of rotational movement of the rotor assembly 402 about axis 304. Alternatively, other bearing configurations including the cups 403 being bearing interfaces may be used without departing from the scope of this disclosure. The cups 403 may also function as a torque transmission spline, with torque being transferred from the rotational movement of the rotor assembly 402 to external components, such as gears of a transmission. An outer surface of one of the cups 403 may also provide an interface for a resolver rotor retaining ring. For example, a retaining ring may be positioned in face sharing contact with and circumferentially surrounding an outer cylindrical surface 457 of the second cup 403b in order to maintain an axial position of a resolver rotor, such as resolver rotor 405 relative to the rotor assembly 402. Thus, a resolver rotor may be positioned circumferentially surrounding a cup, such as the first cup 403a or second cup 403b, and/or a cylindrical protrusion of an end cap, such as the first cylindrical protrusion 444a or the second cylindrical protrusion 444b, as described above.

Because axial load may be carried by the fastener 432 and the retainer 404 while radial load may be carried by the cups 403 and/or the drive end coupling 550, the aforementioned components may be made of steel to meet material property demands (e.g., adequate strength, toughness, and the like to withstand applied forces). Due to the configuration of rotor assembly 402, the end caps 416 may withstand relatively less force, and therefore may be made of aluminum rather than steel. In some examples, due to the lighter weight of aluminum compared to steel, the end caps 416 may be lighter weight than end caps of other rotor assemblies which demand steel end caps, thereby further reducing the weight of the rotor assembly. As used herein, “steel” may include a variety of steel compositions (e.g., carbon steel, alloy steel, stainless steel), and “aluminum” may include aluminum and/or aluminum alloys.

Turning now to FIG. 5, a cross section view 501 of another example rotor assembly 502 according to the present disclosure is shown. Some parts shared with the rotor assembly 402 of FIG. 4 are labeled accordingly in FIG. 5, while others are omitted for clarity.

Similar to the rotor assembly 402 of FIG. 4, the rotor assembly 502 comprises a shaftless rotor 500 fastened by the fastener 432. The shaftless rotor 500 may include the lamination stacks 418, the first end cap 416a including the first flange 442a, the first cup 403a, and a third end cap 516 including a third flange 542, wherein the first flange 442a and the third flange 542 axially align the lamination stacks 418 between the first end cap 416a and the third end cap 516. The third flange 542 of the third end cap 516 may be shaped approximately the same as the first flange 442a and/or may be shaped approximately the same as the second flange 442b shown in FIG. 4 and described above. In this way, the first flange 442a and the third flange 542 may axially align the lamination stacks 418, first end cap 416a, and third end cap 516 such that the centerlines thereof are along the axis 304, without a shaft therethrough in face sharing contact with the lamination stacks 418. Further, the cavity 406 may remain hollow as in rotor assembly 402 of FIG. 4, surrounding the fastener 432 due to the body diameter 401 being less than the inner diameter 410. Additionally, the inner diameter 410 may be greater than an inner diameter formed by conventional lamination stacks, such as lamination stacks 318 of FIG. 3. Further still, similar to the rotor assembly 402, in the configuration of rotor assembly 502, the first end cap 416a and the third end cap 516 may be made of aluminum rather than steel. Thus, resource demand and weight may be reduced due to a reduction in materials used for lamination stacks 418 and material hybridization.

The first cup 403a may be positioned in the first cylindrical protrusion 444a, and the first cylindrical protrusion 444a may be circumferentially surrounded by the resolver rotor 405 and the resolver rotor retainer 409, as described above with regards to FIG. 4. Further, the fastener 432 may extend through the first cup 403a, the first end cap 416a, and the cavity 406 axially along the axis 304 as described above. The fastener 432 may further extend through a hole 536 in the third end cap 516, and into a recess 504 located centrally along axis 304 in a drive end coupling 550, wherein a surface 512 of the drive end coupling 550 may be in face sharing contact with an outer surface 514 of the third end cap 516. In some examples, the fastener 432 may be removably coupled to the recess 504 via threading, pins, and the like. In other examples, the fastener 432 may be coupled to the recess via welding. In at least some examples, the head 456 may apply the first axial force towards the rotor core 408 as described above, and the drive end coupling 550 may apply a third axial force towards the rotor core 408, such that the first axial force and the third axial force are oriented opposite of one another. For example, the first axial force may be in the negative x-direction and the third axial force may be in the positive x-direction. The opposing axial forces may result in compression of the rotor assembly 502. Thus, the fastener 432 may fasten (e,g., rotationally couple and axially affix) the components of the shaftless rotor 500 with the drive end coupling 550 to form the rotor assembly 502.

In at least some examples, the drive end coupling 550 may be adapted to drivingly couple the rotor assembly 502 to a torque converter (e.g., the torque converter 20 of FIG. 1) or a transmission, (e.g., the transmission 208 of FIG. 2). In this way, the drive end coupling 550 may be an alternative to the second cup 403b of rotor assembly 402 in FIG. 4 as the torque transmission spline through which torque may be transferred between the rotor assembly 502 and an external component (not shown). For example, the external component may be a component, such as a gear, of a transmission such as transmission 208 of FIG. 2. In another example, the external component may be a torque converter, such as the torque converter 20 of FIG. 1. The drive end coupling 550 may be shaped with protrusions (e.g., protrusion 510), splines (e.g., 508), indents (e.g., 506), and the like along the exterior surface of the drive end coupling 550 which may fit to a shape of the external component to which the drive end coupling 550 connects. In this way, the drive end coupling 550 may rotationally couple the rotor assembly 502 and the external component. In other examples, the drive end coupling 550 may be shaped differently than as shown, according to the geometry of the external component to which the drive end coupling 550 rotationally couples to. Thus, a rotor assembly according to the present disclosure may have one or more cups, and in some examples a drive end coupling, wherein at least one of the aforementioned components may rotationally and/or drivingly couple to an external component, for example of a transmission.

The technical effect of the rotor assembly disclosed herein is to reduce weight and resource demand of the rotor assembly by eliminating a shaft from the rotor and hybridizing materials to include aluminum components, such as end caps. Thus, due to the absence of a shaft and because aluminum is lighter weight than steel, the rotor assembly according to the present disclosure may overcome at least some of the issues associated with increased weight of a rotor assembly, such that degradation of components may be prevented or delayed and/or operational efficiency may be increased compared to rotors with shafts extending therethrough and in face sharing contact with lamination layers. Additionally, hybridization of materials may reduce resource demand as opposed to other rotor assemblies.

FIGS. 3-5 show example configurations with relative positioning of the various components. FIGS. 4 and 5 are shown approximately to scale, although other relative dimensions may be used. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space therebetween and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Features described as axial may be approximately parallel with an axis unless otherwise specified. Features described as counter-axial may be approximately perpendicular to an axis unless otherwise specified. Features described as radial may circumferentially surround or extend outward from an axis unless otherwise specified.

The disclosure also provides support for a rotor assembly, comprising: a first end cap, a second end cap, a rotor core positioned between the first end cap and the second end cap, a fastener extending axially through a center of the first end cap, through a cavity of the rotor core, and through a center of the second end cap, the fastener affixing the first end cap and second end cap to the rotor core without any other fasteners. In a first example of the system, the system further comprises: one or more cups, wherein the fastener further extends through centers of the one or more cups. In a second example of the system, optionally including the first example, the system further comprises: a retainer, wherein the retainer and fastener apply compressive forces in oriented opposite to one another to components of the rotor assembly. In a third example of the system, optionally including one or both of the first and second examples, the rotor core comprises one or more lamination stacks, the first end cap includes a first flange and the second end cap includes a second flange, and the first flange and second flange extend axially towards each other to align the lamination stacks. In a fourth example of the system, optionally including one or more or each of the first through third examples, at least one of the one or more cups is a journal of a journal bearing. In a fifth example of the system, optionally including one or more or each of the first through fourth examples, the fastener is a bolt. In a sixth example of the system, optionally including one or more or each of the first through fifth examples, the fastener is engagingly coupled to the retainer via complementary threads.

The disclosure also provides support for a rotor assembly, comprising: a rotor core comprised of a plurality of aligned lamination stacks, each lamination stack including a first hole forming a cavity, a fastener positioned within the cavity and spaced away from the plurality of aligned lamination stacks, a first end cap and a second end cap, each of the first end cap and second end cap positioned at axially opposite ends of the fastener and comprising a cylindrical flange adapted to align the plurality of aligned lamination stacks. In a first example of the system, there are no other fasteners. In a second example of the system, optionally including the first example, the system further comprises: one or more cups, wherein the one or more cups are each received by a cylindrical opening defined by a cylindrical protrusion of the first end cap or the second end cap. In a third example of the system, optionally including one or both of the first and second examples, the fastener rotationally couples the rotor core, the first end cap, the second end cap, and the one or more cups. In a fourth example of the system, optionally including one or more or each of the first through third examples, one of the one or more cups or a drive end coupling rotationally couples the rotor assembly to a torque converter. In a fifth example of the system, optionally including one or more or each of the first through fourth examples, the fastener applies axial force to prevent axial movement and radial movement of the rotor core, the first end cap, and the second end cap, relative to one another. In a sixth example of the system, optionally including one or more or each of the first through fifth examples, the fastener axially aligns the first end cap, the second end cap, and the one or more cups to have centerlines along an axis of rotation of the rotor assembly. In a seventh example of the system, optionally including one or more or each of the first through sixth examples, the fastener extends through the first hole, a second hole in the first end cap, and a third hole in the second end cap such that a first end of the fastener is outside of the cavity and a second end of the fastener opposite the first end is outside of the cavity.

The disclosure also provides support for a rotor assembly, comprising: a first end cap and a second end cap, a rotor core comprised of a plurality of lamination stacks positioned axially between the first end cap and the second end cap, a fastener adapted to apply axial force on the first end cap and second end cap to prevent radial movement of the plurality of lamination stacks. In a first example of the system, the fastener extends through the first end cap, the second end cap, and a cavity formed by the plurality of lamination stacks therebetween such that the first end cap and the second end cap are axially aligned. In a second example of the system, optionally including the first example, the first end cap and the second end cap are adapted to axially align the plurality of lamination stacks. In a third example of the system, optionally including one or both of the first and second examples, the fastener applies a first axial force to a first cup, and a drive end coupling applies a second axial force to the second end cap, the first axial force being oriented opposite of the second axial force along an axis of rotation, such that the fastener, the rotor core, the first end cap, the second end cap, a first cup, and the drive end coupling are rotationally coupled. In a fourth example of the system, optionally including one or more or each of the first through third examples, the fastener applies a first axial force to a first cup, and a retainer applies a second axial force to a second cup, the first axial force being oriented opposite of the second axial force along an axis of rotation, such that the fastener, the rotor core, the first end cap, the second end cap, the first cup, and the second cup are rotationally coupled.

In another representation, a hybrid vehicle comprises: an electric machine, wherein the electric machine comprises a stator and a rotor, and wherein the rotor does not include a shaft extending therethrough and includes a single fastener; a resolver, wherein the resolver sends signals to a controller; and an engine.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A rotor assembly, comprising:
a first end cap;
a second end cap;
a rotor core positioned between the first end cap and the second end cap; and
a fastener extending axially through a center of the first end cap, through a cavity of the rotor core, and through a center of the second end cap, the fastener affixing the first end cap and second end cap to the rotor core without any other fasteners.

2. The rotor assembly of claim 1, further comprising one or more cups, wherein the fastener further extends through centers of the one or more cups.

3. The rotor assembly of claim 1, further comprising a retainer, wherein the retainer and fastener apply compressive forces in oriented opposite to one another to components of the rotor assembly.

4. The rotor assembly of claim 1, wherein the rotor core comprises one or more lamination stacks, the first end cap includes a first flange and the second end cap includes a second flange, and the first flange and second flange extend axially towards each other to align the one or more lamination stacks.

5. (canceled)

6. The rotor assembly of claim 1, wherein the fastener is a bolt.

7. The rotor assembly of claim 3, wherein the fastener is engagingly coupled to the retainer via complementary threads.

8. A rotor assembly, comprising:
a rotor core comprised of a plurality of aligned lamination stacks, each lamination stack including a first hole forming a cavity;
a fastener positioned within the cavity and spaced away from the plurality of aligned lamination stacks; and
a first end cap and a second end cap, each of the first end cap and second end cap positioned at axially opposite ends of the fastener and comprising a cylindrical flange adapted to align the plurality of aligned lamination stacks.

9. The rotor assembly of claim 8, wherein there are no other fasteners.

10. The rotor assembly of claim 8, further comprising one or more cups, wherein the one or more cups are each received by a cylindrical opening defined by a cylindrical protrusion of the first end cap or the second end cap.

11. The rotor assembly of claim 10, wherein the fastener rotationally couples the rotor core, the first end cap, the second end cap, and the one or more cups.

12. The rotor assembly of claim 10, wherein one of the one or more cups or a drive end coupling rotationally couples the rotor assembly to a torque converter.

13. The rotor assembly of claim 8, wherein the fastener applies axial force to prevent axial movement and radial movement of the rotor core, the first end cap, and the second end cap, relative to one another.

14. The rotor assembly of claim 10, wherein the fastener axially aligns the first end cap, the second end cap, and the one or more cups to have centerlines along an axis of rotation of the rotor assembly.

15. The rotor assembly of claim 8, wherein the fastener extends through the first hole, a second hole in the first end cap, and a third hole in the second end cap such that a first end of the fastener is outside of the cavity and a second end of the fastener opposite the first end is outside of the cavity.

16. A rotor assembly, comprising:
a first end cap and a second end cap;
a rotor core comprised of a plurality of lamination stacks positioned axially between the first end cap and the second end cap; and
a fastener adapted to apply axial force on the first end cap and second end cap to prevent radial movement of the plurality of lamination stacks.

17. The rotor assembly of claim 16, wherein the fastener extends through the first end cap, the second end cap, and a cavity formed by the plurality of lamination stacks therebetween such that the first end cap and the second end cap are axially aligned.

18. The rotor assembly of claim 16, wherein the first end cap and the second end cap are adapted to axially align the plurality of lamination stacks.

19. The rotor assembly of claim 16, wherein the fastener applies a first axial force to a first cup and a drive end coupling applies a second axial force to the second end cap, the first axial force being oriented opposite of the second axial force along an axis of rotation, such that the fastener, the rotor core, the first end cap, the second end cap, the first cup, and the drive end coupling are rotationally coupled.

20. The rotor assembly of claim 16, wherein the fastener applies a first axial force to a first cup, and a retainer applies a second axial force to a second cup, the first axial force being oriented opposite of the second axial force along an axis of rotation, such that the fastener, the rotor core, the first end cap, the second end cap, the first cup, and the second cup are rotationally coupled.

21. The rotor assembly of claim 2, wherein a hole is formed into the one or more cups.
